(19) United States
(12) Patent Application Publication
(10) Pub. No.: US 2009/0311931 A1
(43) Pub. Date: Dec. 17, 2009

(54) Process For Pretreatment of Cellulose-Based Textile Materials

(75) Inventors: Arja Miettinen-Oinonen, Klaukkala (FI); Jaakko Pere, Vantaa (FI)

Correspondence Address: ARENT FOX LLP, 1050 CONNECTICUT AVENUE, N.W., SUITE 400, WASHINGTON, DC, 20036, US

(73) Assignee: VALTION TEKNILLINEN TUTKIMUSKESKUS, Espoo (FI)

(21) Appl. No.: 12/279,505

(22) PCT Filed: Feb. 16, 2007
(86) PCT No.: PCT/FI2007/050082

§ 371 Date: Nov. 25, 2008

(30) Foreign Application Priority Data
Feb. 17, 2006 (FI) 20065121

(51) Int. Cl. D03D 15/00; D06L 3/10; C11D 3/395; D04H 13/00

(52) U.S. Cl. 442/181; 8/107; 8/110; 510/320; 510/305; 510/306; 442/327; 442/304

(57) ABSTRACT

The invention is related to mild pretreatment or preparation process as well as combined scoring and bleaching composition for cellulose-based textile material. The process comprises a sequential or simultaneous scouring step with an enzyme composition acting on the non-cellulosic material on outer layers of cellulosic fibers and a reducing bleaching step with a reducing bleaching agent. The reducing bleaching agent is preferably dithionite. In the process no adjustment of pH and temperature are required. The process is environmentally friendly because no causticizing and oxidizing agents are required to achieve the desired lightness and wettability. Due to the mild pretreatment conditions tensile strength of the fabric is better than that achieved with conventional pretreatments.

### TECHNICAL FIELD OF THE INVENTION

The present invention is related to a process for pretreatment of cellulose-based textile materials, particularly cotton-containing materials. The process comprises an enzymatic pretreatment step, which is performed in the presence of a reducing bleaching agent. The invention also relates to a composition comprising a mixture of enzymes acting on the non-cellulosic impurities on outer layers of cellulosic fibers and a reducing bleaching agent. Further a pretreated cellulose-based textile material having improved properties is disclosed.

### BACKGROUND OF THE INVENTION

Raw cotton contains, in addition to cellulose, impurities including complex organic compounds, such as oil, waxes, pectins, proteins and less complex substances, including for example nitrogen compounds, organic acids, mineral matter, and natural colouring-matter. The approximate composition of raw cotton is cellulose 85.5%, oil and wax 0.5%, proteins, pectins and colouring-matter 5.0%, mineral matter 1.0%, but the quantity and compositions of the impurities may vary with cultivation conditions, climatic factors and cotton variety.

Most of the non-cellulosic material is located on the outer layer of cotton fiber, called the cuticle. The major structural components are cutin and suberin, heteropolymers of aliphatic and phenolic compounds that are linked by ester bonds and associated with waxes, complex mixtures of hydrophobic material containing very long-chain fatty acids and their derivatives. The pectinic compounds of the cuticle layer mainly consist of neutral and acidic heteropolysaccharides with different molecular weights and degrees of esterification. The outer layers of cotton fiber contain also considerable amounts of protein, hemicellulose and mineral matter.

The purpose of cotton pretreatment or preparation is to remove the non-cellulosic impurities from the cellulosic fibers, and to increase the wettability or the water adsorption ability as well as the whiteness of the fabric, thus improving the performance in dyeing and in any subsequent processing steps, such as printing and finishing. The processing steps included in cotton pretreatment are desizing, scouring and bleaching (FIG. 1). These treatments can be performed continuously or batch-wise.

Enzymes have become a valuable tool in textile processing. In desizing amylases or a complex of amylases consisting of various types of exo- and endo-enzymes, glucoamylases and debranching enzymes with different modes of action have been used in the enzymatic removal of the sizing chemicals, which mainly consist of starch or starch derivatives. These enzymes are commercially available with variable pH and temperature ranges.

Most of the non-cellulosic impurities are removed in the scouring process. The treatment is traditionally performed at high temperature and involves the use of strongly alkaline solutions, such as sodium hydroxide. Bioscouring is an environmentally friendly biological process, which apply enzymes capable of specific targeting and release of non-cellulosic impurities. Generally, the enzymes used for bioscouring do not have any effect on the cellulose backbone and consequently, fiber damage is very limited.

Various enzymes have been proposed to provide effective scouring responses. Scouring of cotton-containing fibers with protopectinases, α-amylases, lipolytic enzymes or combinations thereof has been disclosed, for example in the Japanese patent publication JP 6220772, the Japanese patent application JP 2004218179 and JP 8127960. Scouring processes applying alkaline or thermostable pectin-degrading enzymes are disclosed, for example in the U.S. Pat. No. 5,912,407, the U.S. Pat. No. 6,630,342 and the International patent application WO 00/26464. A method for bleaching a non-cotton cellulosic material with a hemicellulase enzyme is disclosed in the International patent application WO 01/48300. The cellulosic textile materials modified by enzymatic scouring have an enhanced response to a subsequent chemical treatment in the bleaching step.

The intention of bleaching is to remove the coloured impurities, which remain after scouring. Cotton bleaching is mostly carried out with hydrogen peroxide and a desired whiteness of the cotton fabric is achieved, when the hydrogen peroxide is applied at pH 10.5-11 and temperatures close to boiling. The chemical nature of the coloured material in the cotton fiber is not well understood. Therefore, development of an enzymatic bleaching process is still in the developing stage.

Within forest industry oxidative enzymes have been studied in bleaching. In pulp bleaching, laccase-mediator system, directly oxidizing and degrading lignin has been developed. In addition to laccase, manganese peroxidase (MnP) has been studied for its potential in chemical pulp bleaching. In the laccase-mediator concept, the mediator oxidized by laccase enzyme acts directly on lignin and results in efficient delignification. In the initial study, the common substrate of laccases, ABTS was used as the mediator. The search for a more suitable mediator resulted in the use of 1-hydroxybenzotrizole (HBT) in laboratory and in pilot scales. This delignification procedure is commonly referred to as the LMS (laccase-mediator system) or Lignozyme process and it has been demonstrated in pilot scale in totally chlorine free (TCF) bleaching sequence. The LMS system has also been shown to be able to replace either oxygen delignification or ozone stage.

In textile processing a laccase-mediator system is industrially used for decolorization of indigo in denim processing. The invention RU 2148111 describes enzyme treatment of flax fibers using laccase preparation in the presence of special-type redox mediator. As a result, environmentally safe high-whiteness fiber for manufacturing pure-flax yarn is obtained.

Efforts have been made and are still made to reduce the number of steps in the pretreatment of cellulose-based textile materials and to combine desizing, scouring and bleaching. By combining the processes savings of time, water and energy can be obtained, which in turn can reduce the production costs. In the U.S. Pat. No. 6,162,260 a single-bath biopreparation process including dyeing of the textiles is disclosed.

The International patent application WO 03/002810 discloses a single bath desizing, scouring and bleaching method for cellulosic materials. The enzymatic desizing and scouring processes is performed simultaneously or sequentially using an oxidizing peracid bleaching, particularly peracetic acid bleaching. The preferable enzymes used in the method are α- or β-amylases and a pectate lyase. In the Japanese patent applications JP 10088472 and JP 54068402, a method for simultaneous scouring and bleaching of natural cellulosic fibers is carried out by applying a pectic enzyme composition and an oxidative and/or reducing agent. The European patent application EP 1462524 discloses a method to improve property of the cellulose-containing fabric with a cellulase preparation comprising an endoglucanase from Zygomycetes together with a reducing agent. Raw jute degumming process including the use of an enzyme composition and reductive bleaching agent is discloses in the Chinese patent application CN 1614105 and the International patent application WO 200632181. The enzyme composition comprises pectases and laccases. The U.S. Pat. No. 5,338,403 discloses a process for enzymatic hydrolysis of pulp simultaneously with the bleaching with a hydrosulfite. The enzyme is selected from the group consisting of lipase and esterase.

The traditional methods used in scouring and bleaching of cellulose-based textile material use large amounts of chemicals, energy and water. They are time consuming, due to the multiple processing steps at different pH and temperature conditions. To avoid environmental damages, the effluents require neutralization or dilution prior to discharge. The greatest problem occurring during bleaching with peroxide are radical reactions of the bleaching compounds with the fiber, which can lead to decrease in the degree of polymerization and eventually to a decrease in tensile strength, especially in presence of metal ions which act as activators for hydrogen peroxide.

As a remedy for these environmental problems, the use of enzymes for bioscouring have been suggested. However, the current enzymatic scouring processes have not proved to be effective enough to prepare the fabric for dyeing in batch and especially in continuous processes. The whiteness of the bioscoured material has remained lower than the whiteness obtained by using the traditional processes including alkaline wash. Accordingly, the attempts to combine the bioscouring and bleaching steps are not fully satisfactory, because they still involve alkaline conditions, thus causing strength losses and environmental damages.

Consequently, there is a continued demand for alternative environmentally friendly pretreatment processes, which are sufficiently mild and lack any adverse effects on the cellulosic fibers, thereby maintaining the tensile strength of cellulose containing fabric but simultaneously effective enough to provide sufficient whiteness and wettability for further processing, including dyeing and finishing.

### SUMMARY OF THE INVENTION

The objective of the present invention is to solve the above problems by providing an environmentally safe, mild, effective and commercially feasible pretreatment process, which provides a sufficient whiteness and wettability and at the same time maintains the tensile strength of the cellulose-based textile material, particularly cotton based fabrics.

The present invention is related to an enzymatic pretreatment process, which may be applied to both continuous and batch processes and comprises a reducing bleaching step in non-alkaline conditions. The pretreatment, which includes a scouring and bleaching stage, optionally preceded by an enzymatic desizing step is carried out without any oxidizing agents and in neutral or slightly acidic conditions by sequential or simultaneous addition of the composition comprising a mixture of pectinases, esterases and proteases acting on the non-cellulosic impurities on outer layers of cellulosic fibers, followed by or in combination with a composition comprising at least one reducing agent.

Said improved and simplified process may be carried out faster than the traditional process and is performed in conditions, which are milder for the cellulosic material and more environmentally friendly than the traditional pretreatment methods, and therefore result in an improved tensile strength, but which without caustizising and oxidative agents still result in a cellulose-based textile material, which has a quality including desired whiteness and/or wettability that is fully comparable with the quality of a cellulose-based textile material produced with traditional processes. It is demonstrated herein that by the process of the present invention, an equal or better whiteness and wettability and an increased tensile strength, may be achieved in an easier manner than before.

The process can be carried out in a more environmentally friendly manner, in neutral and slightly acidic conditions with mild reagents, which are effective in low concentration, leading to lower chemical, water and energy consumption than the traditional pretreatment process involving separate scouring and bleaching steps and using causticizing and oxidizing agents. By using the process of the present invention production costs are significantly reduced.

Another object of the invention is to provide a scouring and reducing bleaching composition for the use in the process of the present invention. The scouring and bleaching composition is an enzymatic composition comprising a mixture of pectinases, esterases and proteases acting on surface layers of cellulosic fibers combined with at least one reducing bleaching agent. The composition may additionally contain compatible additives, such as buffering substances and chelating agents.

The reducing bleaching agents are advantageously thiourea, thiodioxide, sulfur dioxide, bisulfite, hydrosulfite, borohydride as such or as salts, derivatives or mixtures thereof. Sodium salts are particularly preferred, especially sodium hydrosulfite, also called sodium dithionite, which has been shown to be effective in concentrations as low as 0.1%. Also other organic derivatives as well as non-organic or organic salts of said dithionite as well as mixtures thereof may be used in the pretreatment process of the present invention.

The enzymes applied in the present invention comprise effective amounts of the hydrolytic enzymes pectinases, esterases and proteases. The enzyme composition may further comprise lyases, oxidoreductases, hemicellulases, cellulases or mixtures thereof. Particularly effective are enzyme compositions, which comprise cutinase and suberinase activities.

A further object of the invention is a pretreated cellulose-based textile material. Due to the shortened and milder process the tensile strength of the pretreated cotton is better than that of the same fabric treated with traditional methods including oxidative bleaching agents and alkaline conditions. Despite the shortened and milder process a desired whiteness and wettability for further processing is obtained.

### SHORT DESCRIPTION OF THE DRAWINGS

FIG. 1 shows the steps in treatment of cotton materials, wherein the conventional pretreatment process is used. The process comprises separate steps of scouring with or without enzymes and bleaching with oxidizing agents, such as alkaline hydroxide peroxide.

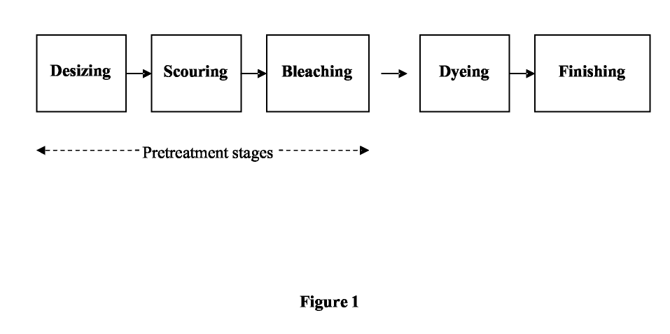

### DETAILED DESCRIPTION OF THE INVENTION

In the present invention the process for pretreatment of a cellulose-based textile material comprises an enzymatic scouring step with a composition comprising a mixture of the hydrolytic enzymes pectinase, esterase and protease acting on the non-cellulosic impurities on outer layers of cellulosic fibers and a reducing bleaching step with a composition comprising a reducing bleaching agent. In one preferred embodiment, the enzyme preparation and reducing bleaching agent are added sequentially to the solution containing the cellulose-based textile material, by first adding the enzyme preparation and incubating, and subsequently adding the reducing bleaching agent and incubating. In another embodiment, the enzyme preparation and reducing bleaching agent are added simultaneously to the liquid solution containing the cellulose-based textile material. The process of the present invention enables all stages to be carried out without essentially adjusting the temperature and pH conditions between the steps and ultimately to carry out the whole process in a single stage.

The present invention is accordingly related to a pretreatment or preparation process of the cellulose-based textile material. The process includes the preparative stages performed to the raw cellulose-based material before dyeing and finishing of the material. These treatments traditionally include the steps of desizing, scouring and bleaching. As a result of these steps, the gray cellulosic material obtains the desired whiteness and is capable of adsorbing the dye in the subsequent dyeing process. The steps of desizing, scouring and bleaching form the wet-processing steps in the treatment of cellulose-based textile material together with the steps of dyeing, printing and finishing. Said pretreatment process is applicable in continuous as well as in batch processes.

In contrast to the conventional or traditional processes, which apply oxidative agents and alkaline conditions, the present invention applies a reducing bleaching step in combination with enzyme treatment. A reducing bleaching is achieved by adding a reducing agent, i.e. a substance that reduces another substance and in doing so it becomes oxidized. The reducing bleaching agents applicable in the process of the invention are any reducing compounds known in the art, which are applicable for cellulosic fibers. Especially useful are thiourea, thiodioxide, sulfur dioxide, bisulfite, hydrosulfite, borohydride as such or as salts, derivatives or mixtures thereof. The preferred reducing agent is a salt or a derivative of bisulfite, hydrosulfite or borohydride. The most preferred reducing agent is sodium hydrosulfite, also known as sodium dithionite.

Dithionite has also been used in bleaching of mechanical pulp. The efficacy of the reductive bleaching in bleaching of mechanical pulp has evidently not, despite the use of relatively high dithionite concentrations, been effective enough to obtain the desired whiteness, because the reductive pulp bleaching processes are preceded or followed by an oxidative stage with hydrogen peroxide, sodium hypochlorite or sodium chlorite. In textile industry, sodium dithionite has primarily been used as a reducing agent for the reduction of vat dyes and sulfur containing dyes. It is also used to optimize the colour fastness as well as in the removal of pigments on textiles that have been dyed in a wrong way and in the reduction of residual hydrogen peroxide after bleaching as a pretreatment for the dye process with reactive dyes. Reducing bleaching agents have not been used as such in pretreatment of cellulose-based textile materials.

Therefore, it was quite surprising to find that an enzymatic scouring with a mixture of pectinases, esterases and proteases acting on the non-cellulosic impurities on outer layers of cellulosic fibers combined with a reducing bleaching agent used in concentrations lower than 1%, provided a pretreated cotton fabric with good tensile strength and sufficient whiteness and wettability. In the present process the effective concentration of sodium dithionite is far lower than the concentration used in the bleaching of mechanical pulp. In one preferred embodiment of the invention the concentration of sodium dithionite used in the process is less than 1%, preferably less than 0.75%, more preferably less than 0.5%, most preferably less than 0.25% per dry weight of the cellulose-based textile material. When using other reducing bleaching agents it is advantageous to choose such agents, which are as effective as sodium dithionite in amounts as low as sodium dithionite.

In contrast to traditional or conventional pretreatment processes, which involve desizing with or without enzymes, such as α-amylase, and scouring at high temperature or boiling with sodium hydroxide or related causticizing agents such as sodium carbonate, potassium hydroxide or mixtures thereof, and bleaching with alkaline hydrogen peroxide, sodium hypochlorite, or sodium chlorite, the present invention works without any oxidative bleaching agents and caustisizing agents.

Environmentally friendly sizing processes include the use of natural biodegradable sizing chemicals, such as starch and starch derivatives or synthetic recyclable formulations, such as polyvinyl alcohol or carboxymethyl cellulose-based sizes. These starch based sizes are originally laid on warp threads in order to reduce mechanical wear during the weaving process and can be desized from the woven fabric or decomposed with the use of enzymes, such as amylases, especially α-amylases or a complex of amylases consisting of various types of exo- and endo-enzymes, glucoamylases and debranching enzymes with different modes of action. These enzymes are commercially available with flexible pH and temperature ranges. In the present invention the desizing may be performed separately or it may be carried out simultaneously with the enzymatic scouring step using enzymes acting on outer layers of cellulosic fibers and further simultaneously with or without the reducing bleaching step.

The conventional scouring aims to remove non-cellulosic impurities to a great extent from cellulosic fiber by saponifying waxes and fats and solubilizing proteins, pectins and hemicelluloses, whereas the present invention advantageously removes said non-cellulosic impurities by specific enzyme mixtures, preferably enzymes mixtures acting on surface layers of cellulosic fibers. Said bioscouring process is based on the idea of particularly targeting the non-cellulosic impurities with specific enzymes, such as hydrolytic enzymes, lyases and oxidoreductases, which modify, degrade and release the non-cellulosic compounds, and thereby the natural pigments, which are associated with said compounds, are lifted off the fiber. Generally, the enzymes used for bioscouring do not have any effect on the cellulose backbone. Bioscouring as such leads to an increased, but not sufficient wettability and whiteness of the fabric. Therefore, bleaching in one or another form is still needed. A sufficiently effective, but mild bleaching, is achieved with the reducing bleaching disclosed in the present invention.

Bleaching aims at the removal of the coloured impurities, which remain after scouring. The cellulose-based textile material is traditionally bleached using oxidizing agents, such as sodium hypochlorite, sodium chlorite or hydrogen peroxide, in many cases a sequence of these bleaching methods are used in combination. Currently, most of the cotton or cellulose-based textile material is bleached with hydrogen peroxide. Hydrogen peroxide, when applied at pH 10.5-11 and temperatures close to the boiling point, produces the desired whiteness of the cellulosic fiber, but may also lead to a decrease in the degree of polymerization and eventually to a drop in tensile strength. In presence of metal ions, which act as activators for hydrogen peroxide said decrease in tensile strength is prone to happen. Another disadvantage of using peroxides in bleaching is the high consumption of water due to the need to neutralize or dilute the alkaline effluents prior to discharge. In order to avoid said negative effects of conventional bleaching, the present invention applies a reducing bleaching, which even in relatively mild pH and temperature conditions in combination with the enzymes acting on outer layers of cellulosic fibers, provides sufficient whiteness and adsorption without destruction of the cellulose fibers.

In the present invention a mixture of hydrolytic enzymes acting on outer layers of cellulosic fibers refers to enzymes used to replace the hydrolytic agents, such as caustic alkali in the scouring process. Suitable enzymes may be produced by the aid of native, mutagenized or genetically modified organisms, such as plants, bacterial or fungal organisms. The enzymes can be chemically modified. The enzymes need not to be isolated and purified, they may advantageously be a crude extract from the enzyme producing organism or the liquid cultivation medium in which said organism has been cultivated and into which said organism has released or secreted the enzyme(s) during cultivation. The medium comprising the enzymes can be used as such or after a clarification process of the culture medium, wherein by centrifugation, filtration or corresponding methods, the enzyme producing organism or cell debris thereof, is removed. Naturally, enzymes may be purified using any feasible method, by which the desired goal is achieved. These purification methods include, for example chromatographic and gel filtration methods, which are well-known in the art.

Enzymes differ in a number of ways, they have different substrate specificities and conditions for optimal performance. The pH optimum of the enzyme is one important factor in textile applications. Most commercial enzymes or enzyme mixtures today are neutral or acidic, having optimum activity in the pH range of 6-8 and 4-6, respectively. Alkaline enzymes, having optimum activity in the pH range of 7.5-10 have been isolated recently. Accordingly, enzymes have different temperature optima. Therefore, a combination of enzymes is selected based on their specificity and the reaction conditions to be applied in the preferred application.

In contrast to most conventional methods, which are carried out in oxidizing and strongly alkaline conditions, the process of the present invention is carried out under reducing and preferably slightly acidic or neutral conditions, which is favourable for the enzyme activity.

The process of the present invention should be carried out at a pH and a temperature, which is optimal for the enzyme mixture used in the process. Enzymes have different pH and temperature optima, varying normally between pH 3-10 and 30-100° C. Usually, the optimal conditions are between pH 4-8 and 40-70° C. The reducing bleaching chemicals also work at the above defined conditions. Therefore, in one preferred embodiment of the invention adjustment of pH is not required during the pretreatment process. In another preferred embodiment the temperature adjustment is not needed. In a more preferred embodiment the process can be carried out without adjustment of pH and temperature.

The enzymes or enzyme mixtures applicable in the pretreatment process of the invention comprise hydrolytic enzymes (EC 3), lyases (EC 4) or oxidoreductases (EC 1) or mixtures thereof. Hydrolytic enzymes comprise such as pectinases, esterases, proteases, hemicellulases, cellulases, or mixtures thereof.

Any pectinolytic enzyme composition with the ability to degrade pectin-containing materials on outer layers of cellulosic fibers can be used in the present invention. The major component in pectic substances is a mainly linear chain of α-D-galacturonic acid units, in which varying proportions of the acid groups are methylated. Other pectic polysaccharides are arabinans, galactans and arabinogalactans. Preferable pectin-degrading hydrolases comprise pectin esterases, pectin methyl esterases, polygalacturonidases, galacturan 1,4-α-galacturonidases or mixtures thereof. In addition to the hydrolytic pectin-degrading enzymes, the pectinolytic composition may further comprise lyase enzymes, such as pectate lyases and pectin lyases.

Esterases hydrolyze ester bonds present in the complex heteropolymers of vascular plants. Preferable esterases comprise carboxylic ester hydrolases, such as sterolesterases, cutinases, lipases, suberinases or mixtures thereof. Lipases further comprise triacylglycerol lipases and phospholipases.

Applicable proteases comprise aspartyl proteases, serine proteases, cysteine proteases, metallo-proteases, aminopeptidases or mixtures thereof.

Hemicellulases comprise xylanases, mannanases, arabinases, galactanases or mixtures thereof.

Cellulases may comprise endo- or exo-acting enzymes, such as endoglucanases and cellobiohydrolases.

Lyases may comprise pectate lyases and pectin lyases.

Oxidoreductases may comprise laccases, peroxidases, lipoxygenases, haloperoxidases or mixtures thereof. In laccase-mediator systems compounds such as 2,2′-azinobis-(3-ethylbezthiazoline-6-sulfonate (ABTS), violuric acid (VA), 2-nitroso-1-naphtol-4-sulphonic acid (HNNS), 1-hydroxybenzotrizole (HBT) and 2,2,6,6-tetramethylpiperidin-1-yloxy (TEMPO) can be used as mediators.

More preferred combinations of surface acting enzymes include mixtures, which contain polygalacturonidase, esterase, cutinase, protease and lipase activity. The enzyme mixtures applied in the present invention preferably have compositions, concentrations and activities, which are similar to those enzyme mixtures used in the experiments, e.g. experimental polyesterase (Genencor International, Inc.), Optimyze esterase (Buckmann Laboratories, Inc.), Lipase PS (Amano Enzyme, Inc.), Purafect OX E protease (Genencor International, Inc.) and a cellulase-free pool of pectinases isolated at the Technical Research Center (Finland) from Pectinex Ultra SP-L (Novozymes A/S), but naturally the composition, concentration and activities of the enzyme mixture may vary depending upon the contents of the cellulose-containing textile material and the applied reducing agent and its concentration.

The enzyme composition may further comprise at least one desizing enzyme, such as an amylase for the simultaneous removal of starch sizing from woven fabric. More preferably, especially α-amylases or a complex of amylases consisting of various types of exo- and endo-enzymes, glucoamylases and debranching enzymes with different modes of action are used in the desizing process. In the present invention the desizing may be performed separately or it may be carried out with enzymatic scouring step with or without the reducing bleaching step.

The enzymes are dosed according to their enzyme activity, determined according to methods common in the art. Esterases can be dosed according to esterase, cutinase or lipase activity, pectinases according to polygalacturonidase activity, proteases according to protease activity and α-amylases according to amylase activity.

The effective amount of lipase activity varies between 10 to 10000 nkat per g of the cellulosic material. More preferably the effective amount of lipase activity varies between 20-5000 nkat and most preferably between 50-1000 nkat per g of the cellulosic material.

The effective amount of esterase activity varies between 10 to 10000 nkat per g of the cellulosic material. More preferably the effective amount of esterase activity varies between 20-5000 nkat and most preferably between 50-2500 nkat per g of the cellulosic material.

The effective amount of polygacturonidase activity varies between 10 to 10000 nkat per g of the cellulosic material. More preferably the effective amount of polygalacturonidase activity varies between 20-5000 nkat and most preferably between 50-1000 nkat per g of the cellulosic material.

The effective amount of protease activity is between 10-10000 nkat per g of the cellulosic material. More preferably the effective amount of protease activity is between 20-5000 nkat and most preferably between 50-1000 nkat per g of the cellulosic material.

The enzyme can also be dosed as milligram of enzyme protein per g of the cellulosic material. The amount of effective enzyme is about 0.05-50 mg protein per g of the cellulosic material. More preferably the amount of enzyme is about 0.1-30 mg protein, most preferably the amount of enzyme is about 0.5-20 mg protein per g of the cellulosic material.

The process of the present invention may advantageously be carried out at a pH, which is as low as pH 3 and up to pH 10. In another preferred embodiment the sequential or simultaneous scouring and reducing bleaching step is performed at pH 4-8, more preferably at pH 5-7, most preferably at pH 6.

The process of the present invention may advantageously be carried out in a temperature varying from 30 to 100° C. In another preferred embodiment the temperature is 40-80° C., more preferably 40-70° C., most preferably 40-50° C.

Advantageously, the enzyme in an enzyme mixture is selected in a way that it has pH and temperature optima at the range that is optimal for the reducing bleaching agent to work effectively and, therefore adjustment of pH or temperature is not needed between the steps.

The pretreatment time depends on various factors, such as the type of enzymes, enzyme concentration, pH and temperature of the process. Preferable pretreatment in batch process varies from about 5 minutes to 24 hours at a fabric-to-liquor ratio of 5:1-50:1.

The sequential or simultaneous scouring step and reducing bleaching step of the present invention may be carried out in the presence of complexing or a chelating agent. Preferably, EDTA at a concentration of about 0.2% of dry weight of the cellulosic material is used. In another embodiment of the invention the sequential or simultaneous scouring step and reducing bleaching step is performed in a solution containing buffering agents. In a further preferred embodiment of the invention other additives like surfactants, optical brighteners and stabilizers may be added to the solution containing the cellulosic material.

The process of the invention is useful in the pretreatment of cellulose-based textile material, such as natural and man-made fibers. In one embodiment of the invention the natural cellulosic fibers comprise fibers such as cotton, linen, flax, ramie, hemp, jute or mixtures thereof. In another embodiment of the invention the man-made cellulosic fibers comprise fibers such as rayon, acetate, viscose, modal or mixtures thereof.

The term cellulose-based textile materials also include blends with other natural and/or man-made cellulosic fibers and/or with synthetic fibers, such as polyester and polyamide. Preferably, the blend material contains more than 10%, preferably more than 20%, more preferably more than 40%, most preferably more than 60% cotton or other natural cellulosic fiber. The cellulose-based textile material comprises fiber, yarn, woven or knitted fabric or garment.

By using the process of the present invention an increased tensile strength and an equal or better whiteness and wettability of the cellulosic textile material may be achieved in an easier manner than by applying a traditional pretreatment process.

Tensile strength or breaking strength of the cellulose-based material means the maximum tensile force recorded in extending a test piece to breaking point. The strength of the material can be measured using methods known in the art, for example according to standard SFS 3981.

In one preferred embodiment of the invention the tensile strength N of the cellulose-based textile material produced by the process is more than 70%, preferably more than 80%, more preferably more than 90%, most preferably 100% of the tensile strength N of the untreated cellulose-based textile material.

Whiteness of the cellulose-based textile material can be measured, for example with Minolta Chroma Meter using L*a*b* system. Increased whiteness is expressed as an increase in the value of lightness L of the fabric or as a decrease in the value of yellowness b.

In one preferred embodiment of the invention the lightness L of the cellulose-based textile material produced by the process is increased by at least 0.5 units, preferably by at least 1 unit, more preferably by at least 2 units, most preferably by at least 3 units compared to the untreated cellulose-based material.

In one preferred embodiment of the invention the yellowness b of the cellulose-based textile material produced by the process is decreased by at least 0.5 units, preferably by at least 1 unit, more preferably by at least 2 units, most preferably by at least 4 units compared to the untreated cellulose-based material.

Wettability or adsorption ability of the treated cellulose-based textile material can be evaluated with methods known in the art, such as the drop test according to BS 4554 or by determining the wetting rate, i.e. velocity as rising height (DIN 53924). Improvement of wetting properties is detected as a decreased value (seconds, s) in drop test and increased value (cm) of rising height.

In one preferred embodiment of the invention the wettability of the cellulose-based textile material produced by the process is in drop test below 20 seconds, preferably below 10 seconds, more preferably below 5 seconds, most preferably below 2.5 seconds.

More preferably the cellulose-based textile material produced by the process has a tensile strength N more than 70%, preferably more than 80%, more preferably more than 90%, most preferably 100% of the tensile strength N of the untreated cellulose-based textile material and a lightness L increased by at least 0.5 units, preferably by at least 1 unit, more preferably by at least 2 units, most preferably by at least 3 units compared to the untreated cellulose-based material or a yellowness b decreased by at least 0.5 units, preferably by at least 1 unit, more preferably by at least 2 units, most preferably by at least 4 units compared to the untreated cellulose-based material or a wettability in drop test is below 20 seconds, preferably below 10 seconds, more preferably below 5 seconds, most preferably below 2.5 seconds.

Even more preferably the cellulose-based textile material produced by the process has a tensile strength N more than 70%, preferably more than 80%, more preferably more than 90%, most preferably 100% of the tensile strength N of the untreated cellulose-based textile material and a lightness L increased by at least 0.5 units, preferably by at least 1 unit, more preferably by at least 2 units, most preferably by at least 3 units compared to the untreated cellulose-based material or a yellowness b decreased by at least 0.5 units, preferably by at least 1 unit, more preferably by at least 2 units, most preferably by at least 4 units compared to the untreated cellulose-based material and a wettability in drop test is below 20 seconds, preferably below 10 seconds, more preferably below 5 seconds, most preferably below 2.5 seconds.

Most preferably the cellulose-based textile material produced by the process has a tensile strength N more than 70%, preferably more than 80%, more preferably more than 90%, most preferably 100% of the tensile strength N of the untreated cellulose-based textile material and a lightness L increased by at least 0.5 units, preferably by at least 1 unit, more preferably by at least 2 units, most preferably by at least 3 units compared to the untreated cellulose-based material and a yellowness b decreased by at least 0.5 units, preferably by at least 1 unit, more preferably by at least 2 units, most preferably by at least 4 units compared to the untreated cellulose-based material and a wettability in drop test is below 20 seconds, preferably below 10 seconds, more preferably below 5 seconds, most preferably below 2.5 seconds.

Another objective of the invention is to provide a scouring and reducing bleaching composition for use in a process for pretreating cellulose-based textile material. The composition comprises a mixture of the hydrolytic enzymes pectinase, esterase and protease acting on the non-cellulosic impurities on outer layers of cellulosic fibers, and at least one reducing bleaching agent. The composition may further comprise a hemicellulase, cellulase, lyase, oxidoreductase or a mixture thereof.

Preferred esterases comprise cutinases, lipases, sterolesterases, suberinases or mixtures thereof. Lipases further comprise triacylglycerol lipases and phospholipases.

Preferable pectinases comprise pectin esterases, pectin methyl esterases, polygalacturonidases, galacturan 1,4-α-galacturonidase or mixtures thereof. In addition to the hydrolytic pectin-degrading enzymes, the composition may further comprise lyase enzymes, such as pectate lyases and pectin lyases. Applicable proteases comprise aspartyl proteases, serine proteases, cysteine proteases, metallo-proteases, aminopeptidases or mixtures thereof. Hemicellulase comprise a xylanase, mannanase, arabinase, galactanase or a mixture thereof. Cellulases may comprise endo- or exo-acting enzymes, such as endoglucanases and cellobiohydrolases.

More preferred combinations of surface acting enzymes include mixtures, which contain polygalacturonidase, esterase, cutinase, protease and lipase activity. The enzyme mixtures advantageously comprise the enzyme in compositions, concentrations or activities which are similar to those in the preparations used in the experiments, including Optimyze esterase (Buckmann Laboratories, Inc.), Lipase PS (Amano Enzyme, Inc.), Purafect OX E protease (Genencor International, Inc.) and a cellulase-free pool of pectinases isolated at the Technical Research Center (Finland) from Pectinex Ultra SP-L (Novozymes A/S).

The enzyme composition may further comprise at least one desizing enzyme, such as an amylase for the simultaneous removal of starch sizing from woven fabric. More preferably especially α-amylases or a complex of amylases consisting of various types of exo- and endo-enzymes, glucoamylases and debranching enzymes with different modes of action are used in the desizing process.

The reducing bleaching agent applicable in the composition comprises thiourea, thio dioxide, sulfur dioxide, bisulfite, hydrosulfite, borohydride as such or as salts, derivatives or mixture thereof. Preferred reducing bleaching agent is a salt or derivative of bisulfite, hydrosulfite or borohydride. More preferred agent is sodium hydrosulfite, also known as sodium dithionite.

The composition may additionally contain compatible additives, such as buffering substances, complexing or chelating agents, surfactants, optical brighteners and stabilizers.

Further object of the present invention is to provide a pretreated cellulose-based textile material, which has improved quality in comparison to the cellulosic material produced by the conventional pretreatment process. The quality of the textile material can be determined by measuring the tensile strength, whiteness and wettability of the treated material.

In a preferred embodiment of the invention the tensile strength N of the material is more than 70%, preferably more than 80%, more preferably more than 90%, most preferably 100% of the tensile strength N of the untreated cellulose-based textile material.

In another preferred embodiment of the invention the lightness L of the material is increased by at least 0.5 units, preferably by at least 1 unit, more preferably by at least 2 units, most preferably by at least 3 units compared to the untreated cellulose-based material.

In another preferred embodiment of the invention the yellowness b of the material is decreased by at least 0.5 units, preferably by at least 1 unit, more preferably by at least 2 units, most preferably by at least 4 units compared to the untreated cellulose-based material.

In another preferred embodiment of the invention the wettability of the material in drop test is below 20 seconds, preferably below 10 seconds, more preferably below 5 seconds, most preferably below 2.5 seconds.

More preferably the cellulose-based textile material produced by the process has a tensile strength N more than 70%, preferably more than 80%, more preferably more than 90%, most preferably 100% of the tensile strength N of the untreated cellulose-based textile material and a lightness L increased by at least 0.5 units, preferably by at least 1 unit, more preferably by at least 2 units, most preferably by at least 3 units compared to the untreated cellulose-based material or a yellowness b decreased by at least 0.5 units, preferably by at least 1 unit, more preferably by at least 2 units, most preferably by at least 4 units compared to the untreated cellulose-based material or a wettability in drop test is below 20 seconds, preferably below 10 seconds, more preferably below 5 seconds, most preferably below 2.5 seconds.

Even more preferably the cellulose-based textile material produced by the process has a tensile strength N more than 70%, preferably more than 80%, more preferably more than 90%, most preferably 100% of the tensile strength N of the untreated cellulose-based textile material and a lightness L increased by at least 0.5 units, preferably by at least 1 unit, more preferably by at least 2 units, most preferably by at least 3 units compared to the untreated cellulose-based material or a yellowness b decreased by at least 0.5 units, preferably by at least 1 unit, more preferably by at least 2 units, most preferably by at least 4 units compared to the untreated cellulose-based material and a wettability in drop test is below 20 seconds, preferably below 10 seconds, more preferably below 5 seconds, most preferably below 2.5 seconds.

Most preferably the cellulose-based textile material produced by the process has a tensile strength N more than 70%, preferably more than 80%, more preferably more than 90%, most preferably 100% of the tensile strength N of the untreated cellulose-based textile material and a lightness L increased by at least 0.5 units, preferably by at least 1 unit, more preferably by at least 2 units, most preferably by at least 3 units compared to the untreated cellulose-based material and a yellowness b decreased by at least 0.5 units, preferably by at least 1 unit, more preferably by at least 2 units, most preferably by at least 4 units compared to the untreated cellulose-based material and a wettability in drop test is below 20 seconds, preferably below 10 seconds, more preferably below 5 seconds, most preferably below 2.5 seconds.

The process of the present invention and the results obtained by said process are illustrated by the following examples.

### Example 1

### Determination of Enzyme Activities

The enzyme activities of different commercial esterases, pectinase and protease were determined. The enzymes were Experimental polyesterase (Genencor International, Inc.), Optimyze esterase (Buckmann Laboratories, Inc.), Lipase PS (Amano Enzyme, In c.), Purafect OX E protease (Genencor International, Inc.) and a cellulase-free pool of pectinases isolated at the Technical Research Center (Finland) from Pectinex Ultra SP-L (Novozymes A/S).

Protease activity was assayed at pH 8 using Protazyme AK tablets (Megazyme International Ireland Ltd., Ireland). α-Amylase was determined according to the method of Ceralpha, ICC Standard no 33 (Megazyme International Ireland Ltd, Ireland). Lipase activity was determined as described in Kontkanen, H., Tenkanen, M., Fagerstrom, R. and Reinikainen, T. (2004) J. Biotechnol. 108, 51-59. Esterase activity was determined by using p-nitrophenylbutyrate as a substrate and as described in Davies, K. A., de Lorono, I., Foster, S. J., Li, D., Johnstone, K. and Ashby, A. M. (2000) Physiol. Mol. Plant. Pathol. 57, 63-75. Cutinase activity was determined as described in Köller, W., Allan, C. R., and Kolattukudy, P. E. (1982) Physiol. Plant Pathol. 20, 47-60 and in Davies, K. A., de Lorono, I., Foster, S. J., Li, D., Johnstone, K. and Ashby, A. M. (2000) Physiol. Mol. Plant. Pathol. 57, 63-75. Polygalacturonidase activity was determined as described in Bailey, M. and Pessa. (1989) Enzyme Microb. Technol. 12, 266-271.

The results of the main and side activities of the preparations are presented in Table 1.

TABLE 1
Enzyme activities of the various enzyme preparations.

| | Protease | α-amylase | Lipase | Esterase | Cutinase | PG |
|---|---|---|---|---|---|---|
| Enzyme | nkat/g | u/ml | nkat/ml | nkat/ml | nkat/ml | nkat/ml |
| Optimyze | na | na | 20 046 | 3377* | 84%* | na |
| Lipase PS | na | na | 238/g | na | na | na |
| Pectinase pool | na | na | | na | na | 950 |
| Experimental | na | na | 13 200 | 10 158 | na | na |
| Polyesterase | | | | | | |
| Purafect OX E | 8220 | 460 | na | na | na | na |

PG = polygalacturonidase
*1 g/10 ml,
na = not analyzed

### Example 2

### Treatment of Cotton with Esterases and Protease

Raw cotton fabric (bed linen 5851, Finlayson Forssa Oy, Finland) was treated with different enzymes and their combinations. 6 g cotton fabric was treated in a laboratory dyeing machine Linitest (Atlas) in 0.1 M sodium phosphate buffer pH 7 in liquid ratio 1:15 at 40° C. for 4 h. Five different types of commercial and experimental enzymes were used in different combinations. The enzymes were Experimental polyesterase (Genencor International Inc.), Optimyze esterase (Buckmann Laboratories, Inc.), Lipase PS (Amano Enzyme, Inc.) and Purafect OX E protease (Genencor International Inc.). The reference treatment was done as the enzyme treatments but without enzyme. Experimental polyesterase, Optimyze and Lipase PS were dosed as nkat of lipase activity per g of fabric. Purafect was dosed as mg of protein per g of fabric. After the treatment the reactions were stopped by rinsing the fabrics twice at 80° C. with water for 10 minutes in liquid ratio 1:50. Thereafter the fabrics were rinsed with water at room temperature. Colour of the fabric was measured with Minolta Chroma Meter using L*a*b* system. Wettability of the treated fabrics was evaluated by drop test according to BS 4554 and by determining the wetting rate (velocity) as rising height (DIN 53924).

TABLE 2
Wettability and colour of the enzyme-treated cotton fabric.

| | | | Lipase | | Drop | Rising | | |
|---|---|---|---|---|---|---|---|---|
| | Polyesterase | Optimyze | PS | Purafect | test | height | | |
| Experiment | nkat/g | nkat/g | nkat/g | mg/g | S | cm* | L** | b*** |
| 1 | — | — | — | — | 300 | 0 | 0 | 0 |
| 2 | — | 1000 | — | — | 33 | 2.0 | 0.4 | 0.2 |
| 3 | 2500 | — | — | — | 273 | 0.6 | 0 | 0.5 |
| 4 | — | — | — | 20 | Na | 5.1 | 0 | 1.3 |
| 5 | 2500 | 1000 | 1000 | — | Na | 3.9 | 0 | 0.2 |
| 6 | 2500 | 1000 | 1000 | 20 | Na | 5.6 | 0 | 1.1 |

na = not analyzed,
*warp direction,
**increase of lightness L,
***decrease of yellowness b

Improvement of wetting properties was detected as decreased value (seconds, s) in drop test and increased value (cm, after 300 seconds) of rising height. The results presented in Table 2 show that wettability of the fabric was improved by all enzymes and their combinations (experiments 2-6). Enzyme combinations (experiments 5 and 6) improved the wetting properties more as compared to individual enzyme products (experiments 2-4). Treatment with Purafect decreased the yellowness of the fabric. No significant effects on the colour of the fabric could be observed with the other enzymes.

### Example 3

### Bleaching of Cotton with Dithionite

Raw cotton fabric (bed linen 5851, Finlayson Forssa Oy, Finland) was bleached with different concentrations of dithionite (Riedel-deHaen). The fabric was placed into the plastics bag. 6 g fabric was flushed with N₂ for 15 min. 0.2% (of dry weight of the fabric) EDTA solution (2.5 g/l) was added and the fabric was incubated at 70° C. for 30 min. 0.1%-1% (of d.w. of the fabric) dithionite was supplemented and the fabric was bleached at 70° C. for 1 h. After bleaching the fabric was rinsed two times with 120 ml water at room temperature and air dried. Colour of the fabric was measured with Minolta Chroma Meter using L*a*b* system.

TABLE 3
Colour of the bleached fabric.

| Dithionite concentration % | L/Increase of L | b/Decrease of b |
|---|---|---|
| 0.1 | 92.2/1.3 | 14.1/2.5 |
| 0.25 | 93.2/2.2 | 12.8/3.5 |
| 0.5 | 93.8/2.8 | 12.0/4.4 |
| 0.8 | 94.0/3.1 | 11.8/4.6 |
| 1.0 | 93.9/3.4 | 11.6/4.9 |

L = lightness, b = yellowness. Values of the untreated fabric: L = 90.9, b = 16.4.

The bleaching effect, detected as an increased lightness and decreased yellowness, was improved according to the dithionite concentration (Table 3).

### Example 4

### Improvement of Lightness with Combination of Enzymes and Bleaching Chemical

Raw cotton fabric (bed linen 5851, Finlayson Forssa Oy, Finland) was treated with combinations of enzymes and thereafter bleached with dithionite. 6 g cotton fabric was treated in Linitest in 0.1 M Na citrate-phosphate buffer pH 6 in liquid ratio 1:15 at 40° C. for 4 h. Five different types of commercial and experimental enzymes were used in different combinations. The enzymes were Experimental polyesterase (Genencor International, Inc.), Optimyze esterase (Buckmann Laboratories, Inc.), Lipase PS (Amano Enzyme, Inc.), Purafect OX E protease (Genencor International, Inc.) and a pool of pectinases isolated at the Technical Research Center (Finland) from Pectinex Ultra SP-L (Novozymes A/S). The reference treatment was done as the enzyme treatments but without enzyme. Experimental polyesterase, Optimyze and Lipase PS were dosed as lipase activity and pectinase as polygalacturonidase activity. Purafect was dosed as mg protein. After the treatment the reactions were stopped by rinsing the fabrics twice at 80° C. with water for 10 minutes in liquid ratio 1:50. Thereafter the fabrics were rinsed twice with water at room temperature.

The enzyme-treated fabrics were bleached with dithionite. The fabric was placed into the plastics bag. The fabric was flushed with N₂ for 15 min. 0.2% (of d.w. of the fabric) EDTA solution (2.5 g/l) was added and the fabric was incubated at 70° C. for 30 min. 0.1% (of d.w. of the fabric) dithionite was supplemented and the fabric was bleached at 70° C. for 1 h. After bleaching the fabric was rinsed two times with 120 ml water at room temperature and air dried. Colour of the fabric was measured with Minolta Chroma Meter using L*a*b* system

TABLE 4
Colour of the enzyme-treated and bleached fabrics.

| | Polyesterase | Optimyze | Lipase PS | Purafect | Pectinase pool | | |
|---|---|---|---|---|---|---|---|
| Experiment | nkat/g | nkat/g | nkat/g | mg/g | nkat/g | L | b |
| 1 | — | — | — | — | — | 92.7 | 13.7 |
| 2 | — | 1000 | 1000 | — | 1000 | 93.0 | 13.0 |
| 3 | 2500 | — | 1000 | — | 1000 | 92.9 | 13.0 |
| 4 | — | 1000 | 1000 | 20 | 1000 | 93.4 | 12.4 |

L = lightness, b = yellowness.
Values of the untreated fabric: L = 90.9, b = 16.4.

The bleaching effect was seen as an increase of lightness and decrease of yellowness of the fabric. The results show that bleaching with dithionite after combined esterase+pectinase treatments improved lightness and decreased yellowness (experiments 2 and 3) as compared to the treatment with plain buffer and dithionite (experiment 1). Further improvement was obtained when protease was used (experiment 4) (Table 4).

By using combinations of enzymes and low dithionite concentration (0.1%) about the same level of bleaching was achieved than by using higher concentration of dithionite alone (0.25-0.5%, Example 3). Thus to obtain a certain bleaching level dithionite concentration can be lowered if the fabric is pretreated with enzymes.

### Example 5

### Improvement of Wettability with Combination of Enzymes and Bleaching Chemical

Raw cotton fabric (bed linen 5851, Finlayson Forssa Oy, Finland) was treated with combinations of enzymes and thereafter bleached with dithionite as described in Example 4. Wettability of the treated fabrics was measured by drop test according to BS 4554.

TABLE 5
Wetting properties of the enzyme-treated and bleached fabrics.

| | Polyesterase | Optimyze | Lipase PS | Purafect | Pectinase pool | Drop test |
|---|---|---|---|---|---|---|
| Experiment | nkat/g | nkat/g | nkat/g | mg/g | nkat/g | seconds |
| 1 | — | — | — | — | — | >300 |
| 2 | — | 1000 | 1000 | — | 1000 | 15 |
| 3 | 2500 | — | 1000 | — | 1000 | 6 |
| 4 | — | 1000 | 1000 | 20 | 1000 | 1 |

Wettability of the fabrics treated with combinations of enzymes and dithionite (experiments 2-4) was clearly improved as compared to the reference treatment in experiment 1 (buffer alone+dithionite) (Table 5).

### Example 6

### Tensile Strength of Cotton Fabric Treated with Combination of Enzymes and Bleaching Chemical

Raw cotton fabric (bed linen 5851, Finlayson Forssa Oy, Finland) was treated with combinations of Optimyze, Lipase PS and pectinase pool and thereafter bleached with dithionite as described in Example 4. Tensile strength of the fabric (weft direction) was measured according to standard SFS 3981.

TABLE 6
Tensile strength of the enzyme-treated and bleached fabrics.

| | Optimyze | Lipase PS | Pectinase pool | Strength |
|---|---|---|---|---|
| Experiment | nkat/g | nkat/g | nkat/g | N/stdev |
| 1 | — | — | — | 16/0.2 |
| 2 | 1000 | 1000 | 1000 | 16/0.6 |

Stdev = standard deviation.

The strength of the fabric treated with combination of Optimyze, Lipase PS and Pectinase pool and dithionite (experiment 2) remained at the same level as the strength of the reference fabric in experiment 1 (buffer alone+dithionite).

### Example 7

### Comparison of the Process of the Present Invention to the Conventional Industrial Process

Raw cotton fabric (bed linen 5851, Finlayson Forssa Oy, Finland) was treated with combinations of Optimyze, Lipase PS and pectinase pool and thereafter bleached with dithionite as described in Example 4. Wettability of the fabric was measured by drop test according to BS 4554. Tensile strength of the fabric (weft direction) was measured according to standard SFS 3981. Reference sample is a raw cotton fabric (bed linen 5851, Finlayson Forssa Oy, Finland) treated in industrial scale process with the conventional pretreatment process comprising alkaline wash and bleaching using hydrogen peroxide.

TABLE 7
Properties of the fabrics obtained with the method of the present
invention and with the conventional industrial process.

| | Lightness | Yellowness | Drop test | Tensile strength |
|---|---|---|---|---|
| Process | L | b | seconds | N |
| Untreated | 90.5 | 16.5 | >600 | 15 |
| Conventional | 93 | 7.0 | 1 | 12 |
| process | | | | |
| Bioprocessed* | 93 | 13.0 | 15 | 16 |
| Bioprocessed** | 93 | 12 | 1 | n.a |

n.a. = not analyzed,
*= Sample 2 in Examples 4 and 5, comprising the combination of Optimyze, Lipase PS and pectinase pool and dithionite,
**= Sample 4 in examples 4 and 5, comprising Optimyze, Lipase, Pectinase pool and protease.

The lightness L and the wetting properties (measured by drop test) of the fabric treated with the Bioprocess was at the same level as with the Conventional process. In contrast to the Conventional process, no strength loss was observed in the fabric treated with the Bioprocess.

1. A process for pretreatment of a cellulose-based textile material comprising a scouring step with an enzyme composition and a bleaching step, characterized in that the enzyme composition comprises a mixture of the hydrolytic enzymes pectinase, esterase and protease acting on the non-cellulosic material on outer layers of cellulosic fibers and the bleaching step is a reducing bleaching carried out by adding a reducing agent.

2. The process for pretreatment of a cellulose-based textile material according to claim 1, characterized in that the enzyme composition and reducing bleaching agent are added sequentially to the solution containing the cellulose-based textile material, comprising (i) adding the enzyme composition and incubating, and subsequently (ii) adding the reducing bleaching agent and incubating.

3. The process for pretreatment of a cellulose-based textile material according to claim 1, characterized in that the enzyme composition and reducing bleaching agent are added simultaneously to the solution containing the cellulose-based textile material.

4. The process according to claim 1, characterized in that the reducing bleaching agent is thiourea, thiodioxide, sulfur dioxide, bisulfite, hydrosulfite, borohydride, as such or as salts, derivatives or mixtures thereof.

5. The process according to claim 4, characterized in that the reducing agent is a salt or a derivative of bisulfite, hydrosulfite or borohydride.

6. The process according to claim 5, characterized in that the reducing agent is sodium hydrosulfite.

7. The process according to claim 1, characterized in that the enzyme composition further comprises a lyase, an oxidoreductase, a hemicellulase, a cellulase or a mixture thereof.

8. The process according to claim 1, characterized in that the esterase is a cutinase, a lipase, a suberinase, a sterolesterase or a mixture thereof.

9. The process according to claim 7, characterized in that the lyase is a pectate lyase, a pectin lyase or a mixture thereof.

10. The process according to claim 7, characterized in that the oxidoreductase is a laccase, a peroxidase, a lipoxygenase, a haloperoxidase or a mixture thereof.

11. The process according to claim 1, characterized in that a tensile strength N of the cellulose-based textile material produced by the process is more than 70%, preferably more than 80%, more preferably more than 90%, most preferably 100% of the tensile strength N of the untreated cellulose-based textile material.

12. The process according to claim 1, characterized in that a lightness L of the cellulose-based textile material produced by the process is increased by at least 0.5 units, preferably by at least 1 unit, more preferably by at least 2 units, most preferably by at least 3 units compared to the untreated cellulose-based material.

13. The process according to claim 1, characterized in that a yellowness b of the cellulose-based textile material produced by the process is decreased by at least 0.5 units, preferably by at least 1 unit, more preferably by at least 2 units, most preferably by at least 4 units compared to the untreated cellulose-based material.

14. The process according to claim 1, characterized in that a wettability of the cellulose-based textile material produced by the process in drop test is below 20 seconds, preferably below 10 seconds, more preferably below 5 seconds, most preferably below 2.5 seconds.

15. A scouring and reducing bleaching composition for use in a process for pretreating cellulose-based textile material, characterized in that the composition comprises a mixture of the hydrolytic enzymes pectinase, esterase and protease acting on the non-cellulosic material on outer layers of cellulosic fibers, and at least one reducing bleaching agent.

16. The scouring and bleaching composition according to claim 15, characterized in that the enzyme composition further comprises a lyase, an oxidoreductase, a hemicellulase, a cellulase or a mixture thereof.

17. The scouring and reducing bleaching composition according to claim 15, characterized in that the esterase is a cutinase, a lipase, a suberinase, a sterolesterase or a mixture thereof.

18. The scouring and bleaching composition according to claim 16, characterized in that the lyase is a pectate lyase, pectin lyase or a mixture thereof.

19. The scouring and bleaching composition according to claim 16, characterized in that the oxidoreductase is a laccase, a peroxidase, a lipoxygenase, a haloperoxidase or a mixture thereof.

20. The scouring and bleaching composition according to claim 15, characterized in that the reducing bleaching agent is thiourea, thiodioxide, sulfur dioxide, bisulfite, hydrosulfite, borohydride, as such or as salts, derivatives or mixtures thereof.

21. The scouring and bleaching composition according to claim 20, characterized in that the reducing agent is a salt or a derivative of bisulfite, hydrosulfite or borohydride.

22. The scouring and bleaching composition according to claim 21, characterized in that the reducing agent is sodium hydrosulfite.

23. A pretreated cellulose-based textile material produced by the process according to claim 1, characterized in that the tensile strength N of the material is more than 70%, preferably more than 80%, more preferably more than 90%, most preferably 100% of the tensile strength N of the raw cellulose-based textile material.

24. The pretreated cellulose-based textile material produced by the process according to claim 1, characterized in that the lightness L of the material is increased by at least 0.5 units, preferably by at least 1 unit, more preferably by at least 2 units, most preferably by at least 3 units compared to the untreated cellulose-based material.

25. The pretreated cellulose-based textile material produced by the process according to claim 1, characterized in that the yellowness b of the material is decreased by at least 0.5 units, preferably by at least 1 unit, more preferably by at least 2 units, most preferably by at least 4 units compared to the untreated cellulose-based material.

26. The pretreated cellulose-based textile material produced by the process according to claim 1, characterized in that the wettability of the material in drop test is below 20 seconds, preferably below 10 seconds, more preferably below 5 seconds, most preferably below 2.5 seconds.
